(19) United States
(12) Patent Application Publication
(10) Pub. No.: US 2023/0394882 A1
(43) Pub. Date: Dec. 7, 2023

(54) INFORMATION PROCESSING APPARATUS, INFORMATION PROCESSING METHOD, AND COMPUTER-READABLE NON-TRANSITORY STORAGE MEDIUM

(71) Applicant: NEC Corporation, Tokyo (JP)

(72) Inventors: Kyota Higa, Tokyo (JP); Yasunori Babazaki, Tokyo (JP); Ryuhei Ando, Tokyo (JP)

(73) Assignee: NEC Corporation, Tokyo (JP)

(21) Appl. No.: 18/203,342

(22) Filed: May 30, 2023

(30) Foreign Application Priority Data
Jun. 6, 2022 (JP) 2022-091610

(51) Int. Cl. G06V 40/20; G06V 20/40

(52) U.S. Cl. CPC G06V 40/20; G06V 20/44

(57) ABSTRACT

An information processing apparatus includes at least one processor, and the at least one processor carries out: a detection process of detecting a person and an object based on sensor information; a recognition process of recognizing an action of the person based on a relevance between the person and the object; and a measurement process of measuring, based on a recognition result of the action, a time period for which the person has continued the action.

This Nonprovisional application claims priority under U.S.C. § 119 on Patent Application No. 2022-091610 filed in Japan on Jun. 6, 2022, the entire contents of which are hereby incorporated by reference.

### TECHNICAL FIELD

The present invention relates to an information processing apparatus, an information processing method, and a computer-readable non-transitory storage medium.

### BACKGROUND ART

A technique has been disclosed which identifies an operation being carried out by an operator in a site in the construction industry or the like where various operations are carried out.

Patent Literature 1 discloses an operation analysis system in which; an object including an operation machine and a person is recognized from measurement data obtained by measuring an operation region; position information of and a feature quantity pertaining to a shape of the recognized object are determined; and an operation carried out in the operation region is determined from the position of the object, a positional relation with other objects, and the feature quantity.

### CITATION LIST

### Patent Literature

[Patent Literature 1]
Japanese Patent Application Publication Tokukai No. 2020-194243

### SUMMARY OF INVENTION

### Technical Problem

For example, in the service industry, a price charged to a service user is determined according to which service has been provided by each service provider and how many hours the service has been provided. Alternatively, in the construction industry, a price charged to a client is determined according to which operation has been carried out by each operator and how many hours the operation has been carried out. Thus, it is necessary in various industries to ascertain a time period for which a chargeable action has been continued. However, in the operation analysis system disclosed in Patent Literature 1, it is impossible to ascertain, for each operator, which operation has been carried out and how many hours the operation has been carried out.

An example aspect of the present invention is accomplished in view of the problems, and its example object is to provide a technique capable of ascertaining, with higher accuracy, a time period for which a person has continued an action.

### Solution to Problem

An information processing apparatus according to an example aspect of the present invention includes at least one processor, the at least one processor carrying out: a detection process of detecting a person and an object based on sensor information; a recognition process of recognizing an action of the person based on a relevance between the person and the object; and a measurement process of measuring, based on a recognition result of the action, a time period for which the person has continued the action.

An information processing method according to an example aspect of the present invention includes: detecting, by at least one processor, a person and an object based on sensor information; recognizing, by the at least one processor, an action of the person based on a relevance between the person and the object; and measuring, by the at least one processor based on a recognition result of the action, a time period for which the person has continued the action.

A computer-readable non-transitory storage medium according to an example aspect of the present invention stores a program for causing a computer to function as an information processing apparatus, the program causing the computer to carry out: a detection process of detecting a person and an object based on sensor information; a recognition process of recognizing an action of the person based on a relevance between the person and the object; and a measurement process of measuring, based on a recognition result of the action, a time period for which the person has continued the action.

### Advantageous Effects of Invention

According to an example aspect of the present invention, it is possible to ascertain, with higher accuracy, a time period for which a person has continued an action.

### BRIEF DESCRIPTION OF DRAWINGS

FIG. 1 is a block diagram illustrating a configuration of an information processing apparatus according to a first example embodiment of the present invention.

FIG. 2 is a flowchart illustrating a flow of an information processing method according to the first example embodiment of the present invention.

FIG. 3 is a schematic diagram illustrating an information processing system according to a second example embodiment of the present invention.

FIG. 4 is a block diagram illustrating a configuration of an information processing system according to a second example embodiment of the present invention.

FIG. 5 is a diagram illustrating an example of action identification information according to the second example embodiment of the present invention.

FIG. 6 is a diagram illustrating an example of a table indicating recognition results according to the second example embodiment of the present invention.

FIG. 7 is a diagram illustrating an example of a method in which a measurement section according to the second example embodiment of the present invention measures a time period in a case where an unidentified action has been recognized.

FIG. 8 is a diagram illustrating an example of an image which is output by an output section according to the second example embodiment of the present invention.

FIG. 9 is a diagram illustrating an example of an image which is included in annotation information according to the second example embodiment of the present invention.

FIG. 10 is a diagram illustrating an example of information indicating a person and an object included in annotation information according to the second example embodiment of the present invention.

FIG. 11 is a diagram illustrating an example configuration of an inference model which is used by a recognition section according to the second example embodiment of the present invention.

FIG. 12 is a diagram illustrating an example of relevant information which is included in annotation information according to the second example embodiment of the present invention.

FIG. 13 is a diagram illustrating another example of relevant information which is included in annotation information according to the second example embodiment of the present invention.

FIG. 14 is a diagram illustrating an example of a table indicating recognition results in a variation of the present invention.

FIG. 15 is a diagram illustrating an example of an image which is output by an output section according to a variation of the present invention.

FIG. 16 is a diagram illustrating an example of an image which is output by an output section according to a variation of the present invention.

FIG. 17 is a block diagram illustrating an example of a hardware configuration of the information processing apparatus according to each of the example embodiments of the present invention.

### EXAMPLE EMBODIMENTS

### First Example Embodiment

The following description will discuss a first example embodiment of the present invention in detail with reference to the drawings. The present example embodiment is a basic form of example embodiments described later.

(Overview of Information Processing Apparatus 1)

An information processing apparatus 1 according to the present example embodiment detects a person and an object based on sensor information, recognizes an action of the person based on a relevance between the person and the object which have been detected, and measures, based on the recognition result, a time period for which the person has continued the action.

The term “sensor information” refers to information output from one or more sensors. Examples of the “sensor information” include: an image output from a camera; information which is output from light detection and ranging (Lidar) and which indicates a distance to a target object; a distance image based on output from a depth sensor; a temperature image based on output from an infrared sensor; position information output using a beacon; a first-person viewpoint image of a wearer output from a wearable camera; and audio data output from a microphone array constituted by a plurality of microphones.

A method in which the information processing apparatus 1 detects a person and an object based on sensor information is not limited, and a known method is used. Examples of a method in which the information processing apparatus 1 detects a person and an object based on sensor information include: a method based on feature quantities of an image of histograms of oriented gradients (HOG), color histograms, a shape, or the like; a method based on local feature quantities around feature points (e.g., scale-invariant feature transform (SIFT)); and a method using a machine learning model (e.g., faster regions with convolutional neural networks (R-CNN)).

In order to measure a time period for which a person has continued an action, the information processing apparatus 1 detects, at a plurality of points in time or in a predetermined time period, a person and an object which are identical with a person and an object, respectively, detected at a certain point in time. In other words, the information processing apparatus 1 detects a person and an object which are identical with a person and an object, respectively, detected based on a certain piece of sensor information based on another piece of sensor information which has been obtained at a timing different from that of the certain piece of sensor information. A method of determining whether or not a person and an object which have been detected by the information processing apparatus 1 based on a certain piece of sensor information are respectively identical with a person and an object which have been detected based on another piece of sensor information output from the sensor at a timing different from that of the certain piece of sensor information is not limited, and a known method is used.

Examples of the method of determining whether or not a person and an object detected by the information processing apparatus 1 based on a certain piece of sensor information are respectively identical with a person and an object detected based on another piece of sensor information output from the sensor at a timing different from that of the certain piece of sensor information include: a method based on a degree of overlap between a circumscribed rectangle of a person (or object) detected based on a certain piece of sensor information and a circumscribed rectangle of a person (or object) detected based on another piece of sensor information obtained at a timing different from that of the certain piece of sensor information; a method based on a degree of similarity between a feature inside a circumscribed rectangle of a person (or object) detected based on a certain piece of sensor information and a feature inside a circumscribed rectangle of the person (or object) detected based on another piece of sensor information obtained at a timing different from that of the certain piece of sensor information; and a method using a machine learning model (e.g., DeepSort).

The term “relevance between a person and an object” refers to what relationship exists between the person and the object. Examples of the “relevance between a person and an object” include a fact that a certain person is related to a certain object, and a fact that a certain person is not related to a certain object.

Examples of a method in which the information processing apparatus 1 recognizes an action of a person based on a relevance between the person and an object include a method of recognizing that, in a case where a relevance between a person and an object indicates a fact that the person is related to the object, the person is carrying out an action using the object. Another example of a method in which the information processing apparatus 1 recognizes an action of a person based on a relevance between the person and an object is a method of recognizing that, in a case where a relevance between a person and an object indicates a fact that the person is not related to the object, the person is carrying out an action without using the object. Thus, the action which the information processing apparatus 1 recognizes can include an action using an object and an action without using an object.

(Configuration of Information Processing Apparatus 1)

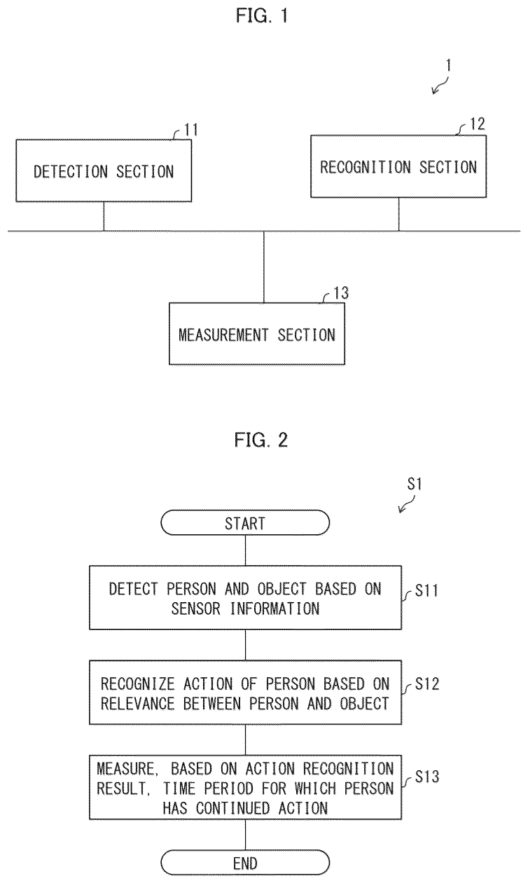

The following description will discuss a configuration of an information processing apparatus 1, with reference to FIG. 1. FIG. 1 is a block diagram illustrating a configuration of the information processing apparatus 1 according to the present example embodiment.

As illustrated in FIG. 1, the information processing apparatus 1 includes a detection section 11, a recognition section 12, and a measurement section 13. The detection section 11, the recognition section 12, and the measurement section 13 are configured to realize the detection means, the recognition means, and the measurement means, respectively, in the present example embodiment.

The detection section 11 detects a person and an object based on sensor information. A method in which the detection section 11 detects a person and an object based on sensor information is as described above. The detection section 11 supplies, to the recognition section 12, information indicating the detected person and object.

The recognition section 12 recognizes, based on a relevance between a person and an object which have been detected by the detection section 11, an action of the person. A method in which the recognition section 12 recognizes an action of a person based on a relevance between the person and an object is as described above. The recognition section 12 supplies a recognition result to the measurement section 13.

The measurement section 13 measures, based on an action recognition result by the recognition section 12, a time period for which the person has continued the action.

As described above, the information processing apparatus 1 according to the present example embodiment employs the configuration of including: the detection section 11 that detects a person and an object based on sensor information; the recognition section 12 that recognizes an action of the person based on a relevance between the person and the object; and the measurement section 13 that measures, based on a recognition result of the action, a time period for which the person has continued the action. For example, the information processing apparatus 1 according to the present example embodiment can measure, for each person, how many hours an action has been continuously carried out. Therefore, according to the information processing apparatus 1 according to the present example embodiment, it is possible to bring about an effect of ascertaining, with higher accuracy, a time period for which a person has continued an action.

(Flow of Information Processing Method S1)

The following description will discuss a flow of an information processing method S1 according to the present example embodiment with reference to FIG. 2. FIG. 2 is a flowchart illustrating the flow of the information processing method S1 according to the present example embodiment.

(Step S11)

In step S11, the detection section 11 detects a person and an object based on sensor information. The detection section 11 supplies, to the recognition section 12, information indicating the detected person and object.

(Step S12)

In step S12, the recognition section 12 recognizes, based on a relevance between the person and the object which have been detected by the detection section 11, an action of the person. The recognition section 12 supplies a recognition result to the measurement section 13.

(Step S13)

In step S13, the measurement section 13 measures, based on an action recognition result by the recognition section 12, a time period for which the person has continued the action.

As described above, the information processing method S1 according to the present example embodiment employs the configuration of including: detecting, by the detection section 11, a person and an object based on sensor information; recognizing, by the recognition section 12, an action of the person based on a relevance between the person and the object which have been detected by the detection section 11; and measuring, by the measurement section 13 based on an action recognition result by the recognition section 12, a time period for which the person has continued the action. Therefore, according to the information processing method S1 of the present example embodiment, an effect similar to that of the foregoing information processing apparatus 1 is brought about.

### Second Example Embodiment

The following description will discuss a second example embodiment of the present invention in detail with reference to the drawings. The same reference numerals are given to constituent elements which have functions identical with those described in the first example embodiment, and descriptions as to such constituent elements are omitted as appropriate.

(Overview of Information Processing System 100)

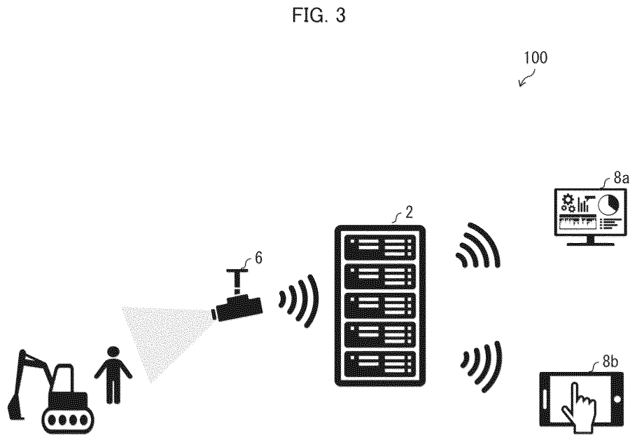

The following description will discuss an overview of an information processing system 100 according to the present example embodiment, with reference to FIG. 3. FIG. 3 is a schematic diagram illustrating the information processing system 100 according to the present example embodiment.

The information processing system 100 detects a person and an object based on sensor information, recognizes an action of a person based on a relevance between the person and the object which have been detected, and measures, based on the recognition result, a time period for which the person has continued the action.

For example, the information processing system 100 is configured to include an information processing apparatus 2, a camera 6, and an output apparatus 8, as illustrated in FIG. 3. In the information processing system 100, the information processing apparatus 2 acquires, as sensor information, an image output from the camera 6 that has imaged a construction site where a person carries out an action using a backhoe or the like. Hereinafter, an action which a person carries out at a construction site is referred to also as an “operation”.

The information processing apparatus 2 detects a person and an object in the construction site based on the acquired image. The present example embodiment will discuss a case where a person is an operator, and an object is an operation object. The information processing apparatus 2 recognizes, based on a relevance between the detected operator and operation object, an operation which the operator is carrying out, and measures, based on the recognition result, a time period for which the operator has continued the operation.

In the information processing system 100, the information processing apparatus 2 outputs the obtained measurement result to the output apparatus 8. Here, the output apparatus 8 is an apparatus that provides information to a user. Examples of the output apparatus 8 include an apparatus that displays an image and an apparatus that outputs audio. In the information processing system 100, for example, as illustrated in FIG. 3, the information processing apparatus 2 outputs a measurement result to at least one of a display apparatus 8a and a tablet 8b.

(Configuration of Information Processing System 100)

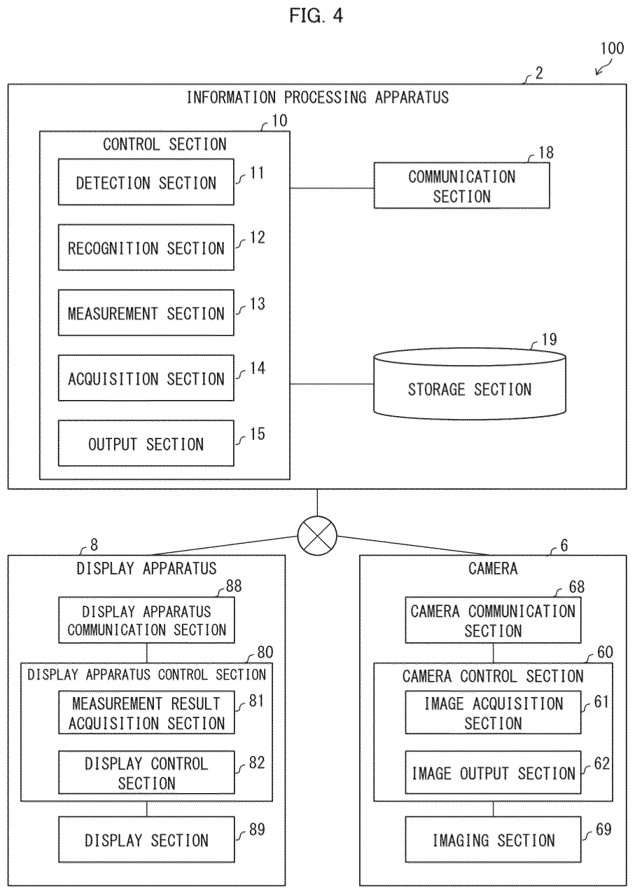

The following description will discuss a configuration of the information processing system 100 according to the present example embodiment, with reference to FIG. 4. FIG. 4 is a block diagram illustrating the configuration of the information processing system 100 according to the present example embodiment.

As illustrated in FIG. 4, the information processing system 100 is configured to include the information processing apparatus 2, the camera 6, and the display apparatus 8 (output apparatus). The information processing apparatus 2, the camera 6, and the display apparatus 8 are communicably connected to each other via a network. A specific configuration of the network does not limited the present example embodiment but, as an example, it is possible to employ a wireless local area network (LAN), a wired LAN, a wide area network (WAN), a public network, a mobile data communication network, or a combination of these networks.

(Configuration of Information Processing Apparatus 2)

As illustrated in FIG. 4, the information processing apparatus 2 includes a control section 10, a communication section 18, and a storage section 19.

The communication section 18 is a communication module that communicates with other apparatuses that are connected via the network. For example, the communication section 18 outputs data supplied from the control section 10 to the display apparatus 8, and supplies data output from the camera 6 to the control section 10.

The storage section 19 stores data which the control section 10 refers to. For example, the storage section 19 stores sensor information and action identification information (described later).

(Function of Control Section 10)

The control section 10 controls constituent elements included in the information processing apparatus 2. As illustrated in FIG. 4, the control section 10 includes a detection section 11, a recognition section 12, a measurement section 13, an acquisition section 14, and an output section 15. The detection section 11, the recognition section 12, the measurement section 13, and the output section 15 are configured to realize the detection means, the recognition means, the measurement means, and the output means, respectively, in the present example embodiment.

The detection section 11 detects an operator and an operation object based on sensor information. A method in which the detection section 11 detects an operator and an operation object based on sensor information is as described above. The detection section 11 supplies, to the recognition section 12, information indicating the detected operator and operation object. An example of a process in which the detection section 11 detects an operator and an operation object will be described later.

The recognition section 12 recognizes, based on a relevance between the operator and the operation object which have been detected by the detection section 11, an action of the operator. An example of a method in which the recognition section 12 recognizes an action of an operator based on a relevance between the operator and an operation object will be described later. The recognition section 12 causes the storage section 19 to store a recognition result.

The measurement section 13 measures, based on an action recognition result by the recognition section 12, a time period for which the operator has continued the action. The measurement section 13 supplies the measurement result to the output section 15. An example of a method in which the measurement section 13 measures a time period for which an operator has continued an action will be described later.

The acquisition section 14 acquires data supplied from the communication section 18. Examples of data acquired by the acquisition section 14 include an image output from the camera 6. The acquisition section 14 causes the storage section 19 to store the acquired data.

The output section 15 outputs data via the communication section 18. For example, the output section 15 outputs a measurement result by the measurement section 13 to the display apparatus 8. With this configuration, the output section 15 can provide a measurement result to a user. Examples of data output by the output section 15 will be described later.

(Configuration of Camera 6)

As illustrated in FIG. 4, the camera 6 includes a camera control section 60, a camera communication section 68, and an imaging section 69.

The camera communication section 68 is a communication module that communicates with other apparatuses that are connected via the network. For example, the camera communication section 68 outputs data supplied from the camera control section 60 to the information processing apparatus 2.

The imaging section 69 is a device that images a subject included in an angle of view. For example, the imaging section 69 images a construction site where an operator and an operation object are included in the angle of view. The imaging section 69 supplies the captured image to the camera control section 60.

The camera control section 60 controls constituent elements included in the camera 6. As illustrated in FIG. 4, the camera control section 60 includes an image acquisition section 61 and an image output section 62.

The image acquisition section 61 acquires an image supplied from the imaging section 69. The image acquisition section 61 supplies the acquired image to the image output section 62.

The image output section 62 outputs data via the camera communication section 68. For example, the image output section 62 outputs an image supplied from the image acquisition section 61 to the information processing apparatus 2 via the camera communication section 68.

(Configuration of Display Apparatus 8)

As illustrated in FIG. 4, the display apparatus 8 includes a display apparatus control section 80, a display apparatus communication section 88, and a display section 89.

The display apparatus communication section 88 is a communication module that communicates with other apparatuses that are connected via the network. For example, the display apparatus communication section 88 supplies data output from the information processing apparatus 2 to the display apparatus control section 80.

The display section 89 is a device that displays an image indicated by an image signal. The display section 89 displays an image indicated by an image signal supplied from the display apparatus control section 80.

The display apparatus control section 80 controls constituent elements included in the display apparatus 8. As illustrated in FIG. 4, the display apparatus control section 80 includes a measurement result acquisition section 81 and a display control section 82.

The measurement result acquisition section 81 acquires a measurement result which is supplied from the display apparatus communication section 88. The measurement result acquisition section 81 supplies the acquired measurement result to the display control section 82.

The display control section 82 supplies, to the display section 89, image data that indicates the measurement result supplied from the measurement result acquisition section 81.

### Example of Process in which Detection Section 11 Tracks Operator

As described in the first example embodiment, the detection section 11 detects a person and an object which are identical with a person and an object, respectively, detected based on a certain piece of sensor information based on another piece of sensor information which has been obtained at a timing different from that of the certain piece of sensor information. The following description will discuss a process example in which the detection section 11 detects, based on sensor information obtained at a timing different from that of a certain piece of sensor information, a person who is identical with a person detected based on the certain piece of sensor information.

First, the detection section 11 detects a person based on an image acquired at a time (t−1). Here, the detection section 11 assigns a detection ID (e.g., an operator ID described later) to the detected person for distinguishing the detected person from another person.

Next, the detection section 11 detects a person based on an image acquired at a time (t). Then, the detection section 11 determines whether or not the person who has been detected based on the image acquired at the time (t) is identical with the person who has been detected in the image acquired at the time (t−1) and to whom the detection ID has been assigned.

For example, the detection section 11 calculates a degree of overlap indicating a degree to which a circumscribed rectangle of the person who has been assigned with the detection ID overlaps a circumscribed rectangle of the person who has been detected based on the image acquired at the time (t). Examples of the degree of overlap of circumscribed rectangles include: a degree to which positions of two circumscribed rectangles overlap; a degree to which sizes of two circumscribed rectangles overlap; and a degree to which features of persons within two circumscribed rectangles overlap.

In a case where the detection section 11 has determined that the person detected based on the image acquired at the time (t) is identical with the person assigned with the detection ID, the detection section 11 assigns the detection ID which has been assigned to the person detected based on the image acquired at the time (t−1) to the person who has been detected in the image acquired at the time (t). With this configuration, the detection section 11 can track the same person among images acquired at different timings.

### Example 1 of Method in which Recognition Section 12 Recognizes Action of Operator

Examples of a method in which the recognition section 12 recognizes an action of an operator include a method in which the recognition section 12 recognizes an action of an operator based on a position of the operator and a position of an operation object.

For example, in a case where a distance between the position of the operator and the position of the operation object is equal to or less than a predetermined length, the recognition section 12 recognizes that the operator is carrying out an operation using the operation object. For example, in a case where a distance between a position of an operator and a position of a handcart is equal to or less than a predetermined length (e.g., 30 cm), the recognition section 12 recognizes that the operator is carrying out transportation, which is an operation using the handcart.

As another example, in a case where a position of an operator overlaps a position of an operation object, the recognition section 12 recognizes that the operator is carrying out an operation using the operation object. For example, in a case where a position of an operator overlaps a position of a backhoe, the recognition section 12 recognizes that the operator is carrying out excavation, which is an operation using the backhoe.

As described above, the recognition section 12 recognizes, based on the position of the operator and the position of the operation object, an action of the operator, and thus can accurately recognize the action by the operator using the operation object. Therefore, it is possible to recognize the action of the operator with higher accuracy.

### Example 2 of Method in which Recognition Section 12 Recognizes Action of Operator

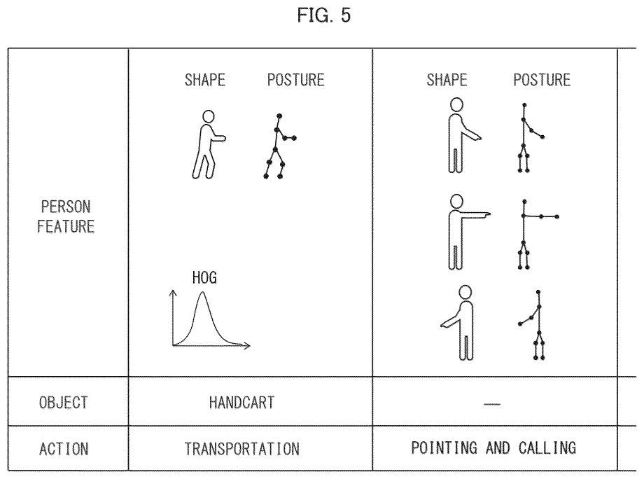

Another example of a method in which the recognition section 12 recognizes an action of an operator is a method in which the recognition section 12 refers to action identification information to recognize an action of an operator detected by the detection section 11. Here, the action identification information indicates a relevance between a feature of the operator in a predetermined action and a feature of an operation object related to the predetermined action. The following description will discuss action identification information with reference to FIG. 5. FIG. 5 is a diagram illustrating an example of action identification information according to the present example embodiment.

As illustrated in FIG. 5, the action identification information indicates a relevance between a person feature (a shape of a person, a posture of a person, and HOG in FIG. 5) in a predetermined action (“transportation” and “pointing and calling” in FIG. 5) and a feature of an object (“handcart” in FIG. 5) related to the predetermined action. The recognition section 12 determines whether or not a person feature of an operator and a feature of an operation object detected by the detection section 11 are identical with a person feature and a feature of an object in the action identification information.

In the action identification information, a plurality of “person features” may be associated with a predetermined action. For example, as illustrated in FIG. 5, in the action identification information, a shape of a person, a posture of a person, and HOG as the “person feature” may be associated with a predetermined action “transportation”.

As illustrated in FIG. 5, the action identification information may include a plurality of shapes of persons, a plurality of postures of persons, and a plurality of HOG in the “person feature”. For example, as illustrated in FIG. 5, in the action identification information, the predetermined action “pointing and calling” may be associated with, as the “person feature”, a shape of a person pointing downward on the right, a shape of a person pointing at a different angle (i.e., a shape of a person pointing in the horizontal direction on the right), and a shape of a person pointing in a different direction (i.e., a shape of a person pointing downward on the left).

Examples of the person feature in action identification information include a color and a local feature quantity, in addition to a shape of a person, a posture of a person, and HOG.

In a case where the person feature of the operator and the feature of the operation object detected by the detection section 11 are identical with the person feature and the feature of the object in the action identification information, the recognition section 12 recognizes that an action associated with the person feature and the feature of the object in the action identification information is an operation which the operator is carrying out.

Meanwhile, in a case where the person feature of the operator and the feature of the operation object detected by the detection section 11 are not identical with the person feature and the feature of the object in the action identification information, the recognition section 12 recognizes that an operation of the operator is an unidentified action, which indicates that the operation could not be identified. In other words, in a case where an action of the operator is not any of a plurality of predetermined actions, the recognition section 12 recognizes that the action of the operator is an unidentified action.

As illustrated in FIG. 5, the action identification information includes: an action (such as the action “transportation”) which is associated with an object “handcart”; and an action (such as the action “pointing and calling”) which is not associated with an object. In other words, an action which the recognition section 12 recognizes includes an action using an object and an action without using an object.

As described above, the recognition section 12 refers to action identification information that indicates a relevance between a feature of an operator in a predetermined action and a feature of an operation object related to the predetermined action, and recognizes an action of the operator detected by the detection section 11. Thus, the recognition section 12 can recognize an action of the operator with higher accuracy.

Moreover, with this configuration, the recognition section 12 can recognize, with higher accuracy, an action of an operator even in a case where the operator carries out an action without using an object.

### Example 3 of Method in which Recognition Section 12 Recognizes Action of Operator

As yet another example of a method in which the recognition section 12 recognizes an action of an operator, there is a method of recognizing an action of an operator based on, in addition to the operator and an operation object, an environment surrounding the operator or the operation object.

For example, in a case where the recognition section 12 has recognized that concrete exists in addition to an operator and an operation object as an environment surrounding the operator or the operation object, the recognition section 12 recognizes that the operator is carrying out an operation of “leveling concrete”.

As described above, the recognition section 12 recognizes an action of an operator based on, in addition to an operator and an operation object, an environment surrounding the operator or the operation object. Thus, the recognition section 12 can recognize, with higher accuracy, an action of the operator.

### Example 4 of Method in which Recognition Section 12 Recognizes Action of Operator

As a still another example of a method in which the recognition section 12 recognizes an action of an operator, in a case where operation objects which have been detected by the detection section 11 based on pieces of sensor information respectively acquired from a plurality of sensors vary depending on the pieces of sensor information, the recognition section 12 may recognize an action of an operator based on an operation object determined based on a majority decision.

For example, in a case where an operation object which has been detected based on sensor information output from a sensor 1 is an object 1, an operation object which has been detected based on sensor information output from a sensor 2 is an object 2, and an operation object which has been detected based on sensor information output from a sensor 3 is the object 1, the recognition section 12 recognizes, based on the object 1, an action of the operator.

Thus, in a case where the detection section 11 has acquired pieces of sensor information respectively from the plurality of sensors, the recognition section 12 recognizes an action of an operator based on an operation object determined based on a majority decision. Therefore, it is possible to reduce erroneous recognition.

### Example 1 of Method in which Measurement Section 13 Measures Time Period

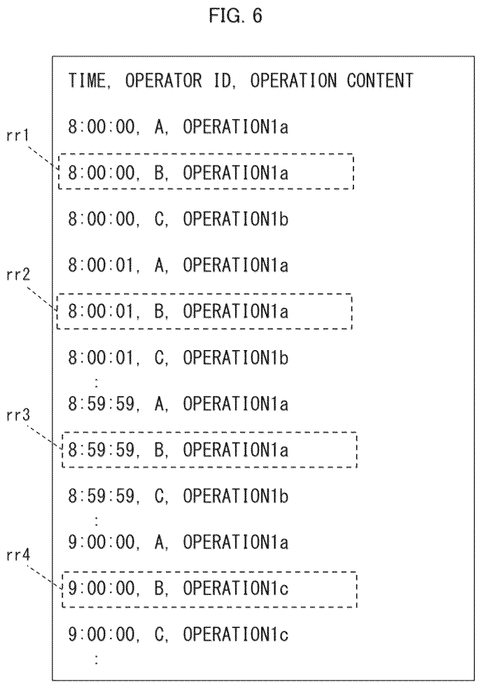

The following description will discuss an example of a method in which the measurement section 13 measures a time period for which an operator has continued an operation, with reference to FIG. 6. FIG. 6 is a diagram illustrating an example of a table indicating recognition results according to the present example embodiment.

First, the recognition section 12 causes the storage section 19 to store, as a recognition result, a time of recognition, an operator ID for distinguishing a recognized operator from another operator, and operation content in association with each other. In this configuration, as illustrated in FIG. 6, the storage section 19 stores a plurality of recognition results in each of which a time, an operator ID, and operation content are associated with each other. The table illustrated in FIG. 6 is a table obtained in a case where the recognition section 12 recognized operation content every second.

The measurement section 13 measures, with reference to the table illustrated in FIG. 6, a time period for which an operator has continued an operation. For example, in a case of measuring a time period for which an operator with an operator ID of “B” has continued operation content “operation 1a”, the measurement section 13 extracts recognition results rr1 through rr4 in which the operator ID is “B”. Next, the measurement section 13 extracts, from the recognition results rr1 through rr4, a time “8:00:00” at which the operation content “operation 1a” was recognized for the first time. Furthermore, the measurement section 13 extracts, from the recognition results rr1 through rr4, a time “9:00:00” at which an operation other than the operation content “operation 1a” was recognized for the first time. Then, the measurement section 13 obtains a difference “1 hour” between the extracted times “8:00:00” and “9:00:00” as a time period for which the operator with the operator ID of “B” has continued the operation content “operation 1a”.

In a case where the same operation content has been intermittently recognized on a time axis by the recognition section 12, the measurement section 13 may measure, as a time period for which a certain operation has been continued, a sum of time periods for which a certain operator has continued the certain operation. For example, the following description assumes a case where an operator with an operator ID of “A” has continued an operation of operation content “operation 1a” for 3 hours, and then has continued an operation of operation content “operation 1b” for 2 hours, and then has continued the operation of operation content “operation 1a” again for another 1 hour. In this case, the measurement section 13 measures that a time period for which the operator with the operator ID of “A” has continued the operation of operation content “operation 1a” is 3 hours+1 hour=4 hours.

The measurement section 13 may measure, as a time period for which a certain operator has continued a certain operation, a value calculated by multiplying the number of times of recognition of a certain operation carried out by the certain operator by a time interval at which the recognition section 12 carries out the recognition process. For example, in a case of measuring a time period for which an operator with an operator ID of “B” has continued operation content “operation aa”, the measurement section 13 extracts recognition results in which the operator ID is “B” in the table illustrated in FIG. 6. Here, the recognition process is carried out at intervals of one second. Therefore, recognition results which are extracted are 3601 results during a period from rr1 (time of 8:00:00) to rr4 (9:00:00). Next, the measurement section 13 calculates, from among the results, the number of pieces “3600” of recognition results associated with the operation content “operation 1a”. Then, the measurement section 13 multiplies the number of pieces “3600” by the time interval “1 second” at which the recognition section 12 carries out the recognition process. Thus, the measurement section 13 measures that a time period for which the operator with the operator ID of “B” has continued the operation of the operation content “operation 1a” is 1 hour. By thus carrying out the method of “multiplying the number of times of recognizing that a certain operator has carried out a certain operation by a time interval of the recognition process”, it is possible to measure a time period for which the certain operation has been carried out, regardless of whether or not recognition results of the same operation content by a certain operator are intermittent on the time axis.

### Example 2 of Method in which Measurement Section 13 Measures Time Period

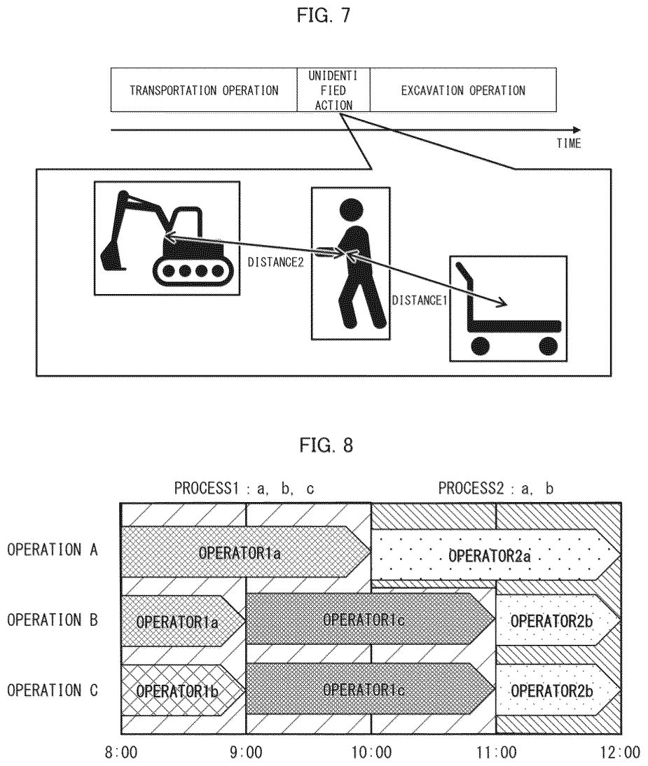

The following description will discuss an example of a method in which the measurement section 13 measures, in a case where an action of an operator recognized by the recognition section 12 is an unidentified action, a time period for which the operator has continued the operation, with reference to FIG. 7. FIG. 7 is a diagram illustrating an example of a method in which the measurement section 13 according to the present example embodiment measures a time period in a case where an unidentified action has been recognized.

An example of a case where an action of an operator recognized by the recognition section 12 is an unidentified action includes an action which is carried out when the operator shifts from a certain operation to another operation. In this case, the measurement section 13 may regard the unidentified action as an operation which the operator has carried out immediately before the unidentified action, or may regard the unidentified action as an operation which the operator has carried out immediately after the unidentified action. The measurement section 13 may regard or determine the unidentified action as one of (i) an operation carried out immediately before the unidentified action and (ii) an operation carried out immediately after the unidentified action, based on a positional relation between an operation object and an operator associated with each of the operation carried out immediately before the unidentified action and the operation carried out immediately after the unidentified action. That is, the measurement section 13 may carry out measurement by adding a time period for which the unidentified action has been continued to a time period for which the operator has continued another action different from the unidentified action.

For example, the following description will discuss a configuration in which the measurement section 13 measures, based on a distance between an operator and an operation object, a time period for which the operator has continued an operation, with reference to FIG. 7. The image illustrated in FIG. 7, which includes an operator and an operation object, is an image indicating a state where the operator carries out a transportation operation using a handcart and then shifts to an excavation operation using a backhoe. In the image illustrated in FIG. 7, the operator is not related to the handcart and is also not related to the backhoe. Therefore, the action is recognized by the recognition section 12 as an unidentified action. In this case, first, the measurement section 13 calculates a distance between the operator and the operation object.

Examples of a method in which the measurement section 13 calculates a distance between an operator and an operation object include, as illustrated in FIG. 7, a method of calculating a distance between a center of a circumscribed rectangle of the operator and a center of a circumscribed rectangle of the operation object. Assuming that a distance between a center of a circumscribed rectangle of the operator and a center of a circumscribed rectangle of the handcart is a distance 1, and a distance between the center of the circumscribed rectangle of the operator and a center of a circumscribed rectangle of the backhoe is a distance 2, the measurement section 13 measures a time period while regarding, as the transportation operation, a period in which a length of the distance 2 is greater than a length of the distance 1 among a period of the unidentified action. Meanwhile, the measurement section 13 measures a time period while regarding, as the excavation operation, a period in which the length of the distance 2 is not more than the length of the distance 1 among the period of the unidentified action.

As described above, the measurement section 13 carries out measurement by adding a time period for which the unidentified action has been continued to a time period for which the operator has continued another action different from the unidentified action. Thus, even in a case where there is a period in which an action of the operator could not be recognized, the measurement section 13 can carry out measurement while regarding such a period as a period of any action. Therefore, it is possible to ascertain, with higher accuracy, a time period for which a person has continued an action.

### Example of Measurement Result Output by Output Section 15

For example, in a construction site, time and progress may be managed by a process including one or more operations. Therefore, the information processing system 100 may present, for each process, a time period for which an operator has continued an operation to a user. In other words, in the information processing system 100, an operation which has been recognized by the recognition section 12 is an operation included in a predetermined process, and the output section 15 may output, in a form in which it is recognizable that the operation is included in the predetermined process, information indicating a time period for which an operator has continued the operation. The following description will discuss an example of data output by the output section 15 in this configuration, with reference to FIG. 8. FIG. 8 is a diagram illustrating an example of an image which is output by the output section 15 according to the present example embodiment.

For example, the following description assumes a case where an “operation 1a”, an “operation 1b”, and an “operation 1c” are included in a “process 1”, and an “operation 2a” and an “operation 2b” are included in a “process 2”. In this case, the output section 15 outputs, in a form in which it is recognizable that an operation is included in a predetermined process, information indicating a time period for which an operator has continued the operation. In the image illustrated in FIG. 8, for example, it is recognizable that the “operation 1a” which an “operator A” has continued during a period between “8:00” and “10:00” is included in the “process 1”. Moreover, as another example of the image illustrated in FIG. 8, it is recognizable that the “operation 2b” which an “operator B” has continued during a period between “11:00” and “12:00” is included in the “process 2”.

Thus, the output section 15 outputs, in a form in which it is recognizable that an operation is included in a predetermined process, information indicating a time period for which an operator has continued the operation. Therefore, it is possible to present, for each process, a time period for which an operation has been carried out to a user.

(Effect of Information Processing Apparatus 2)

As described above, the information processing apparatus 2 according to the present example embodiment employs the configuration of including: the detection section 11 that detects an operator and an operation object based on an image; the recognition section 12 that recognizes an action of the operator based on a relevance between the operator and the operation object; and the measurement section 13 that measures, based on a recognition result of the action, a time period for which the operator has continued the action. Therefore, according to the information processing apparatus 2 according to the present example embodiment, it is possible to bring about an effect of ascertaining, with higher accuracy, a time period for which an operator has continued an action.

(Variation of Detection Section 11)

The detection section 11 may detect an operator and an operation object using a machine learning model. The following description will discuss annotation information that is used in machine learning of a machine learning model, in a case where the detection section 11 uses the machine learning model.

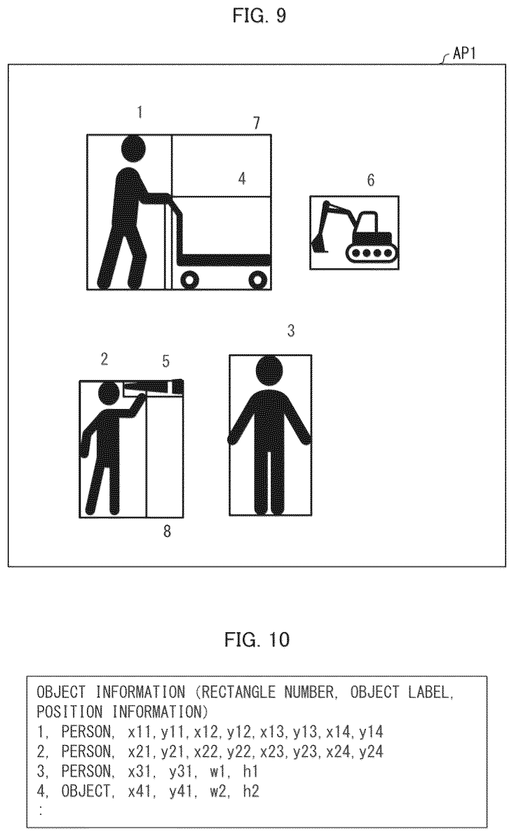

The machine learning model used by the detection section 11 is trained using annotation information in which sensor information is paired with information that indicates a person and an object indicated by the sensor information. The following description will discuss, with reference to FIGS. 9 and 10, an example case where an image is used as sensor information. FIG. 9 is a diagram illustrating an example of an image AP1 which is included in annotation information according to the present variation. FIG. 10 is a diagram illustrating an example of information indicating a person and an object included in annotation information according to the present variation.

As illustrated in FIG. 9, in the image AP1 included in the annotation information, rectangle numbers are respectively assigned to circumscribed rectangles of persons and objects which are included in the image AP1 as subjects. For example, a rectangle number “1” is assigned to a circumscribed rectangle of a person pushing a handcart, and a rectangle number “4” is assigned to a circumscribed rectangle of the handcart.

Next, as illustrated in FIG. 10, information indicating the person and the object included in the annotation information is associated with a rectangle number, an object label indicating whether a person or an object is included in a circumscribed rectangle with the rectangle number, and position information indicating a position of the circumscribed rectangle. For example, a rectangle number “1” which indicates a circumscribed rectangle of a person pushing a handcart is associated with an object label “person” and position information “x11, y11, x12, y12, x13, y13, x14, y14” which indicate positions of four corners of the circumscribed rectangle.

The position information can be represented by information indicating a position of any of the four corners of the circumscribed rectangle and a width and a height of the circumscribed rectangle. For example, as illustrated in FIG. 10, a rectangle number “4”, which indicates a circumscribed rectangle of the handcart, is associated with an object label “object” and with, as position information, “x41, y41” indicating a position of any of four corners of the circumscribed rectangle and a width “w2” and a height “h2” of the circumscribed rectangle.

By thus training the machine learning model used by the detection section 11 with annotation information in which sensor information is paired with information indicating a person and an object indicated by the sensor information, it is possible to train the machine learning model with higher accuracy.

(Variation of Recognition Section 12)

The recognition section 12 may recognize, using an inference model, an action of an operator detected by the detection section 11.

An example of an inference model used by the recognition section 12 is a model into which information indicating a feature of a person and information pertaining to an object are input and from which information indicating a relevance between the person and the object in a predetermined action is output.

In this configuration, the recognition section 12 inputs, into the inference model, information indicating a feature of an operator detected by the detection section 11 and information pertaining to an object detected by the detection section 11. Then, the recognition section 12 recognizes an action of an operator with reference to information that has been output from the inference model and that indicates a relevance between the person and the object in the predetermined action.

For example, in a case where information which has been output from the inference model and which indicates a relevance between a person and an object indicates a fact that the person is related to the object, the recognition section 12 recognizes that the person is carrying out an action using the object. For example, in a case where information which has been output from the inference model and which indicates a relevance between a person and an object indicates a fact that a certain person is related to a handcart, the recognition section 12 recognizes that an operation of the certain person is an operation “transportation” using the handcart.

As described above, the recognition section 12 recognizes an action of an operator detected by the detection section 11 by using the model into which information indicating a feature of a person and information pertaining to an object are input and from which information indicating a relevance between the person and the object in a predetermined action is output. Therefore, the recognition section 12 can recognize, with higher accuracy, an action of an operator.

(Inference Model Used by Recognition Section 12)

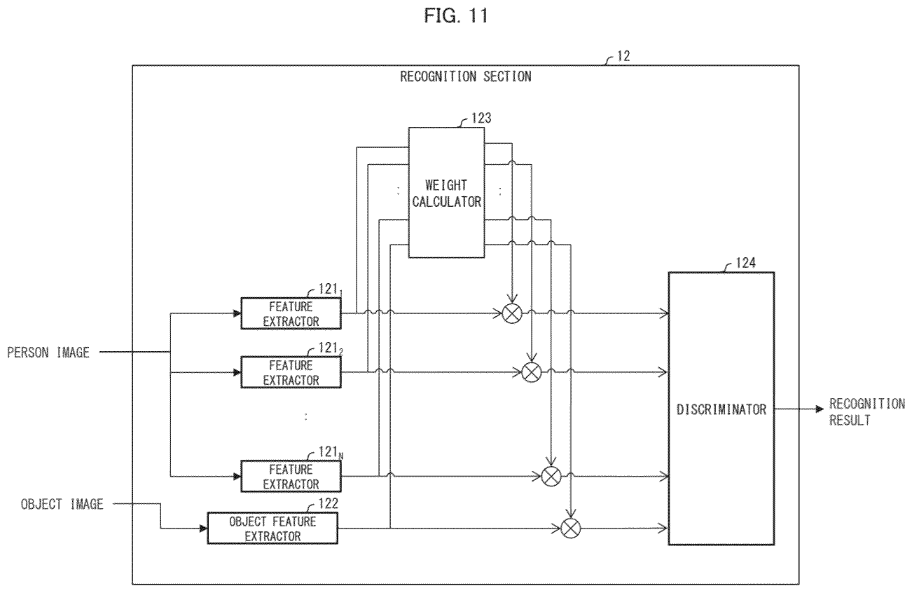

The following description will discuss an example configuration of an inference model used by the recognition section 12, with reference to FIG. 11. FIG. 11 is a diagram illustrating an example configuration of an inference model which is used by the recognition section 12 according to the present variation.

As illustrated in FIG. 11, the recognition section 12 includes a feature extractor 121, an object feature extractor 122, a weight calculator 123, and a discriminator 124.

Into the feature extractor 121, a person image including a person as a subject is input. The feature extractor 121 outputs a feature of the person who is included in the person image as the subject. As illustrated in FIG. 11, the recognition section 12 can be configured to include a plurality of feature extractors 121₁ through 121_{N} that output features of different persons. For example, it is possible to employ a configuration in which the feature extractor 121₁ outputs a feature of a shape of a person who is included in a person image as a subject, and the feature extractor 121₂ outputs a feature of a posture of the person who is included in the person image as the subject.

Into the object feature extractor 122, an object image including an object as a subject is input. The object feature extractor 122 outputs information pertaining to the object which is included in the object image as the subject. The information pertaining to the object output by the object feature extractor 122 can be a feature of the object or can be an object name that specifies the object. The object feature extractor 122 can further include, in output information pertaining to an object, position information indicating a position of the object.

The weight calculator 123 gives weights to respective features output from the feature extractors 121₁ through 121_{N}. In other words, the recognition section 12 refers to a plurality of weighed features.

Into the discriminator 124, a feature output from the feature extractor 121 and information pertaining to an object output from the object feature extractor 122 are input, and the discriminator 124 outputs information indicating a relevance between the person and the object in a predetermined action. In other words, the discriminator 124 outputs, based on a feature output from the feature extractor 121 and information pertaining to an object output from the object feature extractor 122, information indicating a relevance between the person and the object in a predetermined action.

As described above, the discriminator 124 may receive, as input, a plurality of features output from the plurality of feature extractors 121₁ through 121_{N}. In other words, the recognition section 12 can be configured to recognize an action of a person based on a relevance between a plurality of features of the person and information pertaining to the object. With this configuration, the recognition section 12 can recognize, with higher accuracy, an action of a person.

(Machine Learning of Inference Model)

The following description will discuss annotation information that is used in machine learning of an inference model used by the recognition section 12.

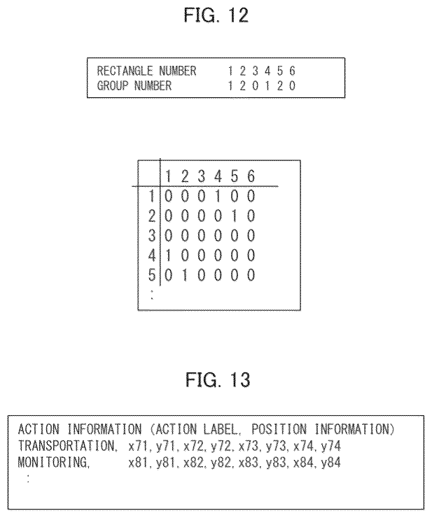

The inference model used by the recognition section 12 is trained using annotation information in which sensor information is paired with relevant information that indicates a relevance between a person and an object indicated by the sensor information. The following description will discuss, with reference to FIGS. 9, 12, and 13, an example case where the foregoing image AP1 indicated in FIG. 9 is used as sensor information. FIG. 12 is a diagram illustrating an example of relevant information which is included in annotation information according to the present variation. FIG. 13 is a diagram illustrating another example of relevant information which is included in annotation information according to the present variation.

As illustrated in FIG. 9, in the image AP1 included in the annotation information, rectangle numbers are respectively assigned to circumscribed rectangles of persons and objects which are included in the image AP1 as subjects. For example, a rectangle number “1” is assigned to a circumscribed rectangle of a person pushing a handcart, and a rectangle number “4” is assigned to a circumscribed rectangle of the handcart. Moreover, as illustrated in FIG. 9, a rectangle number is also assigned to a circumscribed rectangle including a person and an object which are related to each other. For example, a rectangle number “7” is assigned to a circumscribed rectangle including the handcart and the person pushing the handcart.

Next, in the relevant information included in the annotation information, as illustrated in the upper part of FIG. 12, rectangle numbers and group numbers each indicating a relevance are associated with each other. For example, in the upper part of FIG. 12, a rectangle number “1” indicating a person pushing a handcart and a rectangle number “4” indicating the handcart are related to each other, and therefore a group number “1” is associated to both of the rectangle numbers.

As illustrated in the lower part of FIG. 12, the relevant information can be in a matrix form. For example, in the lower part of FIG. 12, a value at a position where a column (or row) of the rectangle number “1” indicating a person pushing a handcart and a row (or column) of the rectangle number “4” indicating the handcart intersect with each other is “1” which indicates that there is a relevance.

The relevant information indicating a relevance between a person and an object can be configured to include an action label indicating an action of the person and position information. For example, as illustrated in FIG. 13, the relevant information can be configured to include (i) position information “x71, y71, x72, y72, x73, y73, x74, y74” indicating positions of four corners of a circumscribed rectangle of a person pushing a handcart and the handcart and (ii) an action label “transportation” indicating an operation of the person pushing the handcart.

By thus training the inference model used by the recognition section 12 with annotation information in which sensor information is paired with relevant information indicating a relevance between a person and an object indicated by the sensor information, it is possible to train the inference model with higher accuracy.

(Variation of Measurement Section 13)

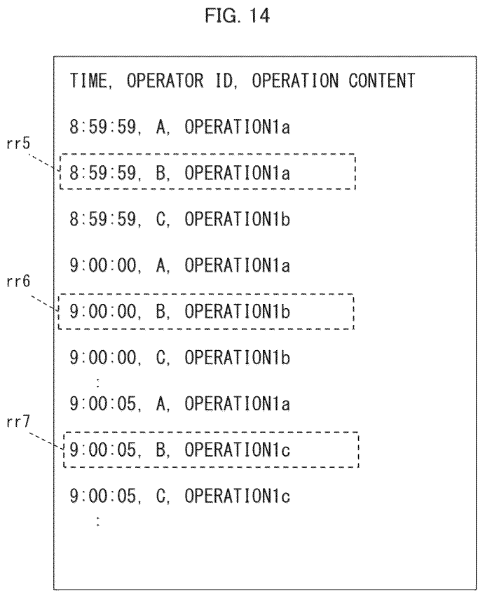

The measurement section 13 can have a configuration in which, in a case where a duration of an operation is less than a predetermined time period (e.g., 15 seconds, 1 minute, or the like), the duration of the operation is included in a duration of an operation which is carried out immediately before that operation or in a duration of an operation which is carried out immediately after that operation. The following description will discuss this configuration with reference to FIG. 14. FIG. 14 is a diagram illustrating an example of a table indicating recognition results in the present variation.

In a case where the recognition results by the recognition section 12 are as indicated in the table illustrated in FIG. 14, the measurement section 13 measures, with reference to the table illustrated in FIG. 14, a time period for which an operator has continued an operation. For example, the measurement section 13 extracts recognition results rr5 through rr7 in which the operator ID is “B”, and measures a time period for which the operator with the operator ID of “B” has continued the operation. Here, the following description assumes a configuration in which, in a case where a duration of the operation is less than 15 seconds, the duration of the operation is included in a duration of an operation which is carried out immediately before that operation. In the example of the table illustrated in FIG. 14, the time period for which the operator with the operator ID of “B” has carried out operation content “operation 1b” is “4 seconds” between “9:00:00” and “9:00:04”. In this case, the measurement section 13 includes the period between “9:00:00” and “9:00:04” in a duration of an operation of operation content “operation 1a”, which is an operation carried out immediately before the operation content “operation 1b”.

In a case where a duration of an operation is short, there is a high possibility of erroneous recognition by the recognition section 12. However, as in the above configuration, the measurement section 13 can ascertain, with higher accuracy, a time period for which a person has continued an action even in a case where a duration of the operation is less than a predetermined time period and the recognition section 12 has made erroneous recognition by including the duration of that operation in a duration of an operation carried out immediately before that operation or in a duration of an operation carried out immediately after that operation.

(Variation 1 of Output Section 15)

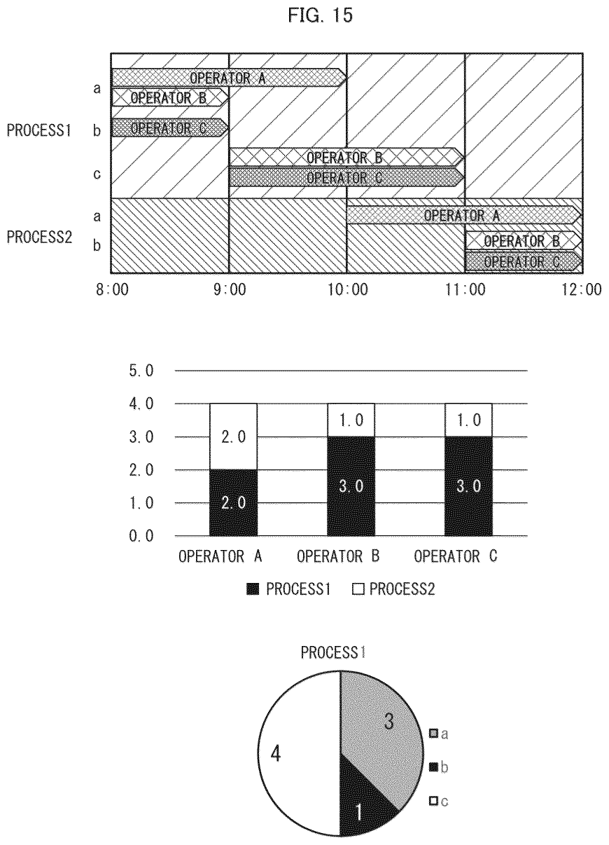

The following description will discuss a variation of the output section 15 with reference to FIG. 15. FIG. 15 is a diagram illustrating an example of an image which is output by the output section 15 according to the present variation.

As in the image illustrated in the upper part of FIG. 15, the output section 15 may output, for each operation content, a time period for which an operator has continued the operation. For example, the image illustrated in the upper part of FIG. 15 indicates that an “operation a” included in a “process 1” has been carried out by an “operator A” during a period between “8:00” and “10:00”, and by an “operator B” during a period between “8:00” and “9:00”.

As in the graph illustrated in the middle part of FIG. 15, the output section 15 may output, for each operator, a sum of time periods for which a process including an operation carried out by the operator has been carried out. For example, the graph illustrated in the middle part of FIG. 15 indicates that an operator A carried out an operation included in a “process 1” for a total of 2 hours, and carried out an operation included in a “process 2” for a total of 2 hours.

As in the graph illustrated in the lower part of FIG. 15, it is possible to output, for each process, a sum of time periods for which an operation included in that process has been carried out. For example, the graph illustrated in the lower part of FIG. 15 indicates that, in the “process 1”, an “operation a” was carried out for 3 hours in total, an “operation b” was carried out for 1 hour in total, and an “operation c” was carried out for 4 hours in total.

The output section 15 may output measurement results respectively related to a plurality of actions in an order based on the measurement results. For example, the output section 15 may output measurement results in decreasing order of time period for which an operator has continued the “operation a”. For another example, the output section 15 may output measurement results in decreasing order of time period for which an operator has continued the “process 1”.

Thus, the output section 15 outputs, for each operation content, for each operator, and for each process, a time period for which the operator has continued the operation. Therefore, it is possible to output a measurement result in a mode intended by the user.

(Variation 2 of Output Section 15)

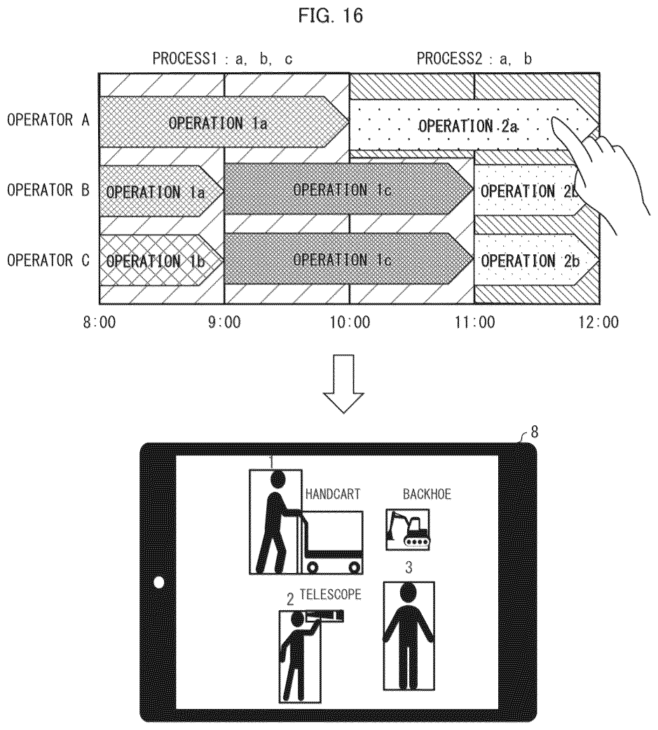

The following description will discuss another variation of the output section 15 with reference to FIG. 16. FIG. 16 is a diagram illustrating an example of an image which is output by the output section 15 according to the present variation.

The output section 15 may be configured to acquire, from the display apparatus 8, information indicating a user operation with respect to the display apparatus 8, and carry out a process in accordance with the information. For example, the following description assumes a case where the output section 15 outputs an image indicated in the upper part of FIG. 16, and the display apparatus 8 displays the image. In this case, upon receipt of a user operation of selecting an “operation 2a” by an “operator A” carried out between “11:30” and “12:00”, the display apparatus 8 outputs information indicating the user operation to the information processing apparatus 2.

Upon acquisition of the information output from the display apparatus 8, the output section 15 of the information processing apparatus 2 outputs an image with reference to the information. For example, the output section 15 outputs an image of a period between a start time “10:00” and an end time “12:00” of a recognized “operation 2a” by an “operator A”, as illustrated in the lower part of FIG. 16.

As another example, the output section 15 divides, by a predetermined time period, an image to be displayed. Then, the output section 15 outputs an image that is in a period indicated by acquired information and that includes an image in which an operation indicated by the acquired information has been recognized. In this configuration, for example, it is assumed that the output section 15 acquires information indicating that a user has selected an “operation 2a” by an “operator A” carried out during a period between “11:30” and “12:00”. In this case, when the image to be displayed is divided by 30 minutes, the output section 15 outputs an image that is recognized to be of the “operation 2a” by the “operator A” and that is for 30 minutes between “11:30” and “12:00”. As another example, in a case where an image to be displayed is divided by one hour, the output section 15 outputs an image for one hour including a period between “11:30” and “12:00” (e.g., an image for a period between “11:00” and “12:00”).

In a case where an image to be displayed is divided by a predetermined time period, the output section 15 can be configured to present the predetermined time period to a user. For example, in the image illustrated in the upper part of FIG. 16, the output section 15 may display a dashed line indicating that the image is divided by a predetermined time period.

Here, the image displayed by the output section 15 can be a moving image or a still image.

Thus, the output section 15 outputs an image in accordance with a user operation. Therefore, it is possible to output an image intended by the user.

### Software Implementation Example

The functions of part of or all of the information processing apparatuses 1 and 2 can be realized by hardware such as an integrated circuit (IC chip) or can be alternatively realized by software.

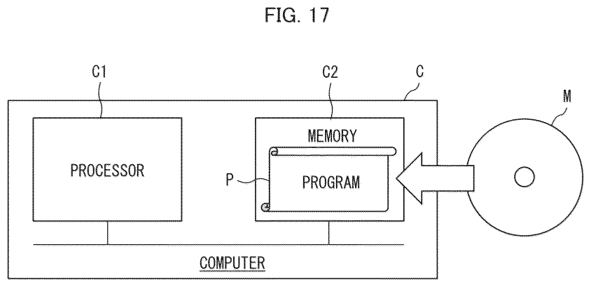

In the latter case, each of the information processing apparatuses 1 and 2 is realized by, for example, a computer that executes instructions of a program that is software realizing the foregoing functions. FIG. 17 illustrates an example of such a computer (hereinafter, referred to as “computer C”). The computer C includes at least one processor C1 and at least one memory C2. The memory C2 stores a program P for causing the computer C to function as the information processing apparatuses 1 and 2. In the computer C, the processor C1 reads the program P from the memory C2 and executes the program P, so that the functions of the information processing apparatuses 1 and 2 are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

[Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional Remark 2]

Some of or all of the foregoing example embodiments can also be described as below. Note, however, that the present invention is not limited to the following supplementary notes.

(Supplementary Note 1)

An information processing apparatus, including: a detection means of detecting a person and an object based on sensor information; a recognition means of recognizing an action of the person based on a relevance between the person and the object; and a measurement means of measuring, based on a recognition result of the action, a time period for which the person has continued the action.

(Supplementary Note 2)

The information processing apparatus according to supplementary note 1, in which: the recognition means refers to action identification information to recognize an action of the person detected by the detection means, the action identification information indicating a relevance between a feature of a person in a predetermined action and a feature of an object related to the predetermined action.

(Supplementary Note 3)

The information processing apparatus according to supplementary note 1, in which: the recognition means uses an inference model to recognize an action of the person detected by the detection means; into the inference model, information indicating a feature of the person and information pertaining to the object are input; and from the inference model, information indicating a relevance between the person and the object in a predetermined action is output.

(Supplementary Note 4)

The information processing apparatus according to any one of supplementary notes 1 through 3, in which: the recognition means recognizes an action of the person based on a relevance between a plurality of features of the person and information pertaining to the object.

(Supplementary Note 5)

The information processing apparatus according to supplementary note 4, in which the recognition means refers to a plurality of weighed features.

(Supplementary Note 6)

The information processing apparatus according to any one of supplementary notes 1 through 5, in which: the recognition means recognizes an action of the person based a position of the person and a position of the object.

(Supplementary Note 7)

The information processing apparatus according to any one of supplementary notes 1 through 6, in which: in a case where an action of the person is not any of a plurality of predetermined actions, the recognition means recognizes that the action of the person is an unidentified action; and the measurement means carries out measurement while adding a time period for which the unidentified action has been continued to a time period for which the person has continued another action different from the unidentified action.

(Supplementary Note 8)

The information processing apparatus according to any one of supplementary notes 1 through 7, further including: an output means of outputting a measurement result by the measurement means to an output apparatus.

(Supplementary Note 9)

The information processing apparatus according to supplementary note 8, in which: the action which has been recognized by the recognition means is an operation included in a predetermined process; the output means outputs, in a form in which it is recognizable that each of operations is included in the predetermined process, information indicating a time period for which the person has continued that operation.

(Supplementary Note 10)

The information processing apparatus according to supplementary note 8 or 9, in which: the output means outputs measurement results respectively related to the actions in an order based on the measurement results.

(Supplementary Note 11)

An information processing method, comprising: detecting, by an information processing apparatus, a person and an object based on sensor information; recognizing, by the information processing apparatus, an action of the person based on a relevance between the person and the object; and measuring, by the information processing apparatus based on a recognition result of the action, a time period for which the person has continued the action.

(Supplementary Note 12)

A program for causing a computer to function as an information processing apparatus, the program causing the computer to function as: a detection means of detecting a person and an object based on sensor information; a recognition means of recognizing an action of the person based on a relevance between the person and the object; and a measurement means of measuring, based on a recognition result of the action, a time period for which the person has continued the action.

(Supplementary Note 13)

An information processing apparatus, including at least one processor, the at least one processor carrying out: a detection process of detecting a person and an object based on sensor information; a recognition process of recognizing an action of the person based on a relevance between the person and the object; and a measurement process of measuring, based on a recognition result of the action, a time period for which the person has continued the action.

Note that the information processing apparatus can further include a memory. The memory can store a program for causing the processor to carry out the detection process, the recognition process, and the measurement process. The program can be stored in a computer-readable non-transitory tangible storage medium.

### REFERENCE SIGNS LIST

1, 2: Information processing apparatus
6: Camera
8: Display apparatus
11: Detection section
12: Recognition section
13: Measurement section
15: Output section
100: Information processing system

1. An information processing apparatus, comprising at least one processor, the at least one processor carrying out:
a detection process of detecting a person and an object based on sensor information;
a recognition process of recognizing an action of the person based on a relevance between the person and the object; and
a measurement process of measuring, based on a recognition result of the action, a time period for which the person has continued the action.

2. The information processing apparatus according to claim 1, wherein:
in the recognition process, the at least one processor refers to action identification information to recognize an action of the person detected in the detection process, the action identification information indicating a relevance between a feature of a person in a predetermined action and a feature of an object related to the predetermined action.

3. The information processing apparatus according to claim 1, wherein:
in the recognition process, the at least one processor uses an inference model to recognize an action of the person detected in the detection process;
into the inference model, information indicating a feature of the person and information pertaining to the object are input; and
from the inference model, information indicating a relevance between the person and the object in a predetermined action is output.

4. The information processing apparatus according to claim 1, wherein:
in the recognition process, the at least one processor recognizes an action of the person based on a relevance between a plurality of features of the person and information pertaining to the object.

5. The information processing apparatus according to claim 1, wherein:
in the recognition process, in a case where an action of the person is not any of a plurality of predetermined actions, the at least one processor recognizes that the action of the person is an unidentified action; and
in the measurement process, the at least one processor carries out measurement while adding a time period for which the unidentified action has been continued to a time period for which the person has continued another action different from the unidentified action.

6. The information processing apparatus according to claim 1, wherein:
the at least one processor further carries out an output process of outputting a measurement result obtained in the measurement process to an output apparatus.

7. The information processing apparatus according to claim 6, wherein:
the action which has been recognized in the recognition process is an operation included in a predetermined process; and
in the output process, the at least one processor outputs, in a form in which it is recognizable that each of operations is included in the predetermined process, information indicating a time period for which the person has continued that operation.

8. The information processing apparatus according to claim 6, wherein:
in the output process, the at least one processor outputs measurement results respectively related to the actions in an order based on the measurement results.

9. An information processing method, comprising:
detecting, by at least one processor, a person and an object based on sensor information;
recognizing, by the at least one processor, an action of the person based on a relevance between the person and the object; and
measuring, by the at least one processor based on a recognition result of the action, a time period for which the person has continued the action.

10. A computer-readable non-transitory storage medium storing a program for causing a computer to function as an information processing apparatus, the program causing the computer to carry out:
a detection process of detecting a person and an object based on sensor information;
a recognition process of recognizing an action of the person based on a relevance between the person and the object; and
a measurement process of measuring, based on a recognition result of the action, a time period for which the person has continued the action.
